(19) United States
(12) Patent Application Publication
(10) Pub. No.: US 2007/0111726 A1
(43) Pub. Date: May 17, 2007

(54) User profiles for mobile terminals

(75) Inventors: Aric B. Lambert, Cary, NC (US); Paul W. Carpenter, Raleigh, NC (US); Allen Michael East, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/273,848

(22) Filed: Nov. 15, 2005

(51) Int. Cl. H04Q 7/20

(52) U.S. Cl. 455/432.1

(57) ABSTRACT

A roaming user profile is stored in a remote profile database accessible via a mobile communication network. The roaming user profile stores configuration information and settings for a mobile terminal. The configuration settings may relate to the user interface, customizable features of applications, and programmable functions of the mobile terminal. The roaming user profile can be accessed remotely by a mobile terminal in response to a login event to retrieve the configuration settings for a user and to configure the mobile terminal.

### BACKGROUND

Improvements in display, processor and memory technology have reached the point that mobile terminals, once used primarily for voice communications, can now function as small handheld computers. Users can manage personal information such as address books, contact lists, calendars, and e-mails using applications running on their mobile terminal. The mobile terminal may also serve as a media player allowing users to play or view media content, such as images, video, and audio. Mobile terminals often include a sophisticated graphic operating system with a graphical user interface similar to a desktop computer. Users can customize the graphical user interface, for example, by installing custom wallpapers, themes, and ring tones. Individual applications may also allow users to set preferences and options according to the user's needs and personal preferences. Users may also download personal files to the mobile terminal.

While improving the user experience, the ever increasing functionality of mobile terminals presents some challenges. One problem is the difficulty encountered when a user replaces a mobile terminal. The process of configuring the mobile terminal and downloading personal files can be a tedious and time consuming process. Currently, there is no way to transfer user customizations of the operating environment and the data files from one mobile terminal to another. Thus, the user must spend significant time to configure their new mobile terminal when an old mobile terminal is replaced. Another problem is encountered when a user needs to borrow or lease a mobile terminal. The user is not likely to be familiar with the features of the borrowed or leased mobile terminal. Also, the experience of using a borrowed or leased mobile terminal will be less rewarding because the borrowed or leased mobile terminal has not been customized to suit the user's preferences.

### SUMMARY

A roaming profile for a mobile terminal user may be stored in a centralized database in a network that can be accessed through a mobile communication network. The roaming profile stores a user's individualized settings for the mobile terminal that control the operating environment, the function of programmable features, and application preferences. For example, the roaming profile may specify specific wallpapers, screensavers, or ring tones. The roaming profile may also include account and billing information. A mobile terminal may, responsive to a login event, access the remote profile database in the network to retrieve and load the user's roaming profile. Thus, the user can have his or her own personal settings applied to any mobile terminal that the user may happen to use.

### BRIEF DESCRIPTION OF THE DRAWINGS

FIG. 1 illustrates an exemplary mobile communication network.

FIG. 2 is a block diagram illustrating the main functional elements of an exemplary mobile terminal.

FIG. 3 is a front view of an exemplary mobile terminal.

FIGS. 4A and 4B are flow charts illustrating an exemplary login procedure.

### DETAILED DESCRIPTION

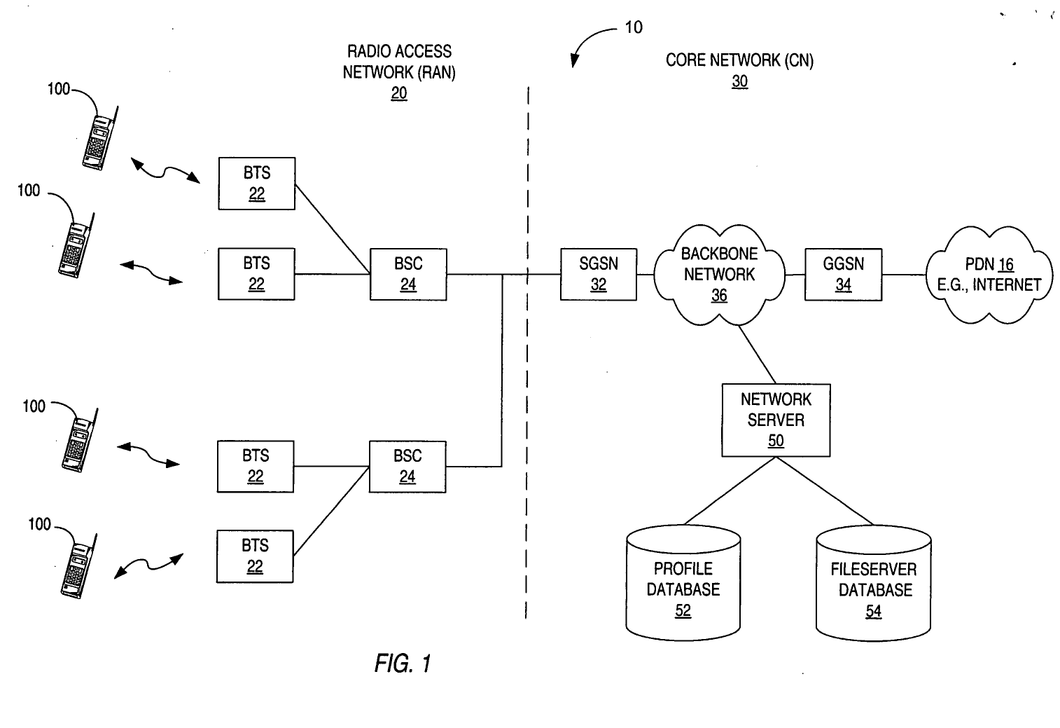

FIG. 1 illustrates the main functional elements of an exemplary mobile communication network 10. The mobile communication network 10 may, for example, comprise a GSM/GPRS network, cdma2000 network, or Wideband CDMA network. The network architecture shown in FIG. 1 is based on the GSM and GPRS standards. The mobile communication network 10 includes a radio access network (RAN) 20 and a core network (CN) 30. RAN 20 supports radio communications with mobile terminals 100 over an air interface. CN 30 provides a connection to the Internet 16 and other external packet data networks (PDNs) for packet switched services, and may provide a connection to the Public Switched Telephone Network (PSTN) and/or the Integrated Digital Services Network (ISDN) for circuit-switched services, such as voice and fax services.

RAN 20 comprises a plurality of base transceiver stations (BTSs) 22 and one or more base station controllers (BSCs) 24. A single BTS 22 and BSC 24 is referred to collectively herein as a base station. The BTS 22 is the radio part of the base station and contains the radio equipment for communicating with the mobile terminals 100. The BSC is the control part of the base station that manages the radio resources and provides connection to the core network 30. The functions performed by BSC 24 include allocating radio resources, terminating air interface layer 2 and layer 3 protocols, diversity combining, scheduling, power control, etc. A single BSC 24 may function as the control part for multiple base stations.

The core network 30 comprises one or more serving GPRS support nodes (SGSNs) 32 and at least one gateway GPRS support node (GGSN) 34. The SGSN 32 is responsible for most session management, QoS management, mobility management, and authentication functions. The GGSN 34 serves as a gateway between the core network 30 and external IP networks. The SGSNs 32 and GGSNs 34 are connected by an IP backbone network 36.

FIG. 1 also illustrates a network server 50, profile database 52, and fileserver database 54 located within the core network 30. The function of these elements is to enable roaming user profiles as will be hereinafter described. Those skilled in the art will recognize, however, that these elements could also be located in an external network that is accessible to mobile terminals 100 via the mobile communication network 10.

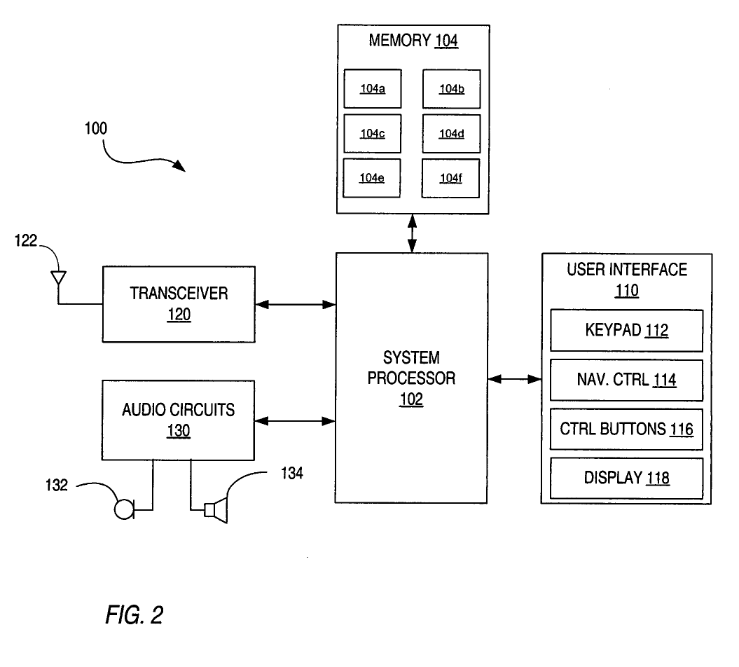

FIG. 2 illustrates the main functional elements of the mobile terminal 100. Mobile terminal 100 comprises a system processor 102, memory 104, a user interface 110, a wireless transceiver 120, audio circuits 130, a microphone 132, and a speaker 134. Mobile terminal 100 is capable of both voice and packet data communications.

System processor 102 controls the overall operation of the mobile terminal 100 according to programs stored in memory 104. The control functions may be implemented in a single processor, or in multiple processors. Suitable processors may include general purpose microprocessors, microcontrollers, digital signal processors, hardware, firmware, or a combination thereof. Memory 104 represents the entire hierarchy of memory in the mobile terminal 100, and may include both random access memory (RAM) and read-only memory (ROM). Computer programs and data required for operation are stored in non-volatile memory, such as EPROM, EEPROM, and/or flash memory, which may be implemented as discrete devices, stacked devices, or may be integrated with one or more processors. Computer programs stored in memory include an operating system program 104a, such as Windows CE, as well as various application programs 104b-104d, such as email clients 104b, web browsers calendar programs 104c, and contact management programs 104d. These programs may be stand alone programs or part of a single integrated program. Memory 104 may also store user accounts 104e and user data 104f. User accounts 104e include individual user profiles and other information used by the operating system 104a.

The user interface 110 includes one or more user input devices and a display 118. The user input devices may comprise any known computer input device. The exemplary embodiment includes a keypad 112, a navigation control 114, and a plurality of control buttons 116. Keypad 112 is a conventional numeric keypad. The navigation control 114 comprises a joystick control. Other pointing devices, such as a touch pad or scroll wheel, may also be used as a navigation control 114. The control buttons 116 may have different functions assigned depending on the current operating mode. In a preferred embodiment, the function of the control buttons 116 is programmable by the user. A voice recognition system or touch screen display may also be used to receive user input. Display 118 preferably presents a graphical user interface to the user. Through the graphical user interface 118, the user can view information such as menus, menu options, and output from various applications. The graphical user interface 118 may allow certain display properties, such as wallpapers, backgrounds, and screensavers to be changed by the user to suit the user's preferences.

Transceiver 120 is coupled to antenna 122 for receiving and transmitting signals. Transceiver 120 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA.

Audio circuits 130 receive analog audio inputs from microphone 132 and provide basic analog output signals to speaker 134. Microphone 132 converts the detected speech and other audible signals into electrical audio signals and speaker 134 converts analog audio signals into audible signals that can be heard by the user.

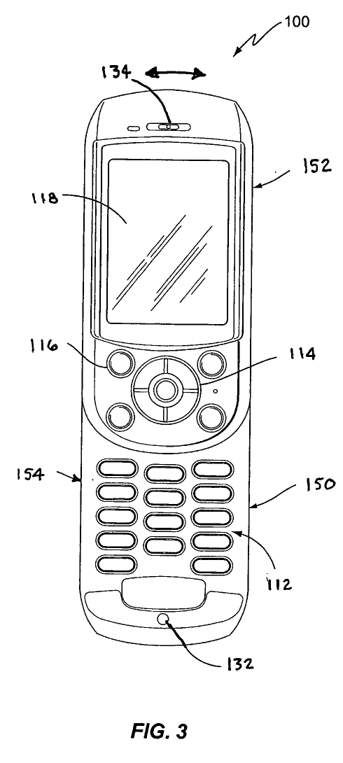

FIG. 3 illustrates the physical appearance of an exemplary mobile terminal 100. Mobile terminal 100 includes a housing 150 containing the circuit elements shown in FIG. 2. The housing 150 includes first and second housing sections 152 and 154 that are pivotally connected to one another. The top housing section 152 is pivotally movable between open and closed positions. FIG. 3 illustrates housing section 152 in the open position. Joystick control 114, control buttons 116, display 118, and speaker 134 are disposed on a top face of housing section 152 so as to be accessible to the user when the housing section 152 is in either the open or closed position. Keypad 112 is disposed on a top face of housing section 154 and is covered when housing section 152 is in the closed position.

Improvements in display, memory, and processing technology have enabled mobile terminals 100 to function as small handheld computers. The operating system 104a provides a graphical user interface similar to that used on many personal computers. The operating system 104a provides a platform for running a host of applications. For example, mobile terminal 100 may be sold with applications such as a contact manager, email client, web browser, and one or more media players. The operating system 104a allows the user to customize the working environment and settings that control how the mobile terminal 100 operates. For example, operating system 104a may allow the user to customize user interface elements such as desktop wallpapers, screen savers, icons, menus, and ring tones. Individual applications 104b-104d on the mobile terminal 100 may also allow customization by the user. For example, a web browser may allow the user to store bookmarks, or to set preferences for how cookies and pop-up windows are handled. The mobile terminal 100 may further include programmable functions that can be programmed by the user to customize the way the mobile terminal 100 operates to suit the user. For example, programmable functions may be used to assign preset functions to the control buttons 116. The user settings that control the operating environment, program settings, programmable functions, and other customizable features of the mobile terminal 100 are stored in a user profile in a local memory 104 or cache in the mobile terminal 100. The user profile may comprise a single file or a collection of files. In addition to the customizable features of the mobile terminal 100 and its applications, the user may enter and store user data 104f in the mobile terminal 100. Such user data 104f may include phone and address books, calendars, emails, media files, and various types of data files.

Operating system 104a allows individual user accounts 104e to be set up for different users. For example, a phone that is shared by a family may include a separate user account 104e for each family member. A separate user profile is associated with each user account 104e so that each individual user can customize the mobile terminal 100 to suit their preferences. A login script is executed when the mobile terminal 100 is turned on, prompting the user to log in. The user may log in, for example, by entering a user name and password. When the user logs in, system processor 102 accesses the user's profile stored in memory 104 and sets up the operating environment, program settings and programmable functions according to the user's profile, i.e., loads the user's profile. If desired, each user profile may include separate account and billing information so that each individual user can be billed separately for his or her use. The service operator may, as a service to its customers, bill the individual user separately or list each user's charges separately on a single statement.

A user may spend a significant amount of time customizing the mobile terminal 100 to suit the user's preferences. The user may also spend significant time inputting data, such as contact lists, calendars, and address books, and copying files into the memory 104 of the mobile terminal 100. A problem may therefore be encountered when the user replaces the mobile terminal 100. In the past, the user must repeat the entire process of customizing the mobile terminal 100 and inputting data into the memory 104 of the mobile terminal 100 when it is replaced.

According to one aspect of the present invention, the customizable user settings and preferences stored in the local user profile may be uploaded to a centralized database within the mobile communication network 10 along with the user's data files. When a user replaces their mobile terminal 100, the user can download their user profile containing their customized settings and preferences from the centralized database to their new mobile terminal 100 along with selected data files. For example, if the user has custom desktop wallpapers or ring tones, the image files and sound files associated therewith may be downloaded with the user profile. Thus, the tedious process of customizing the mobile terminal 100 is avoided.

FIG. 1 illustrates an exemplary centralized database, which comprises a network server 50, a user profile database 52 for storing user profiles, and a separate file server database 54 for storing user files. The centralized database may be located in the core network 30, or in an external network accessible via the mobile communication network 10. The mobile terminal 100 may send requests to the network server 50 and the network server 50 services the requests. Examples of typical requests include a request to download a user profile from the profile database, a request to retrieve a specified data file from the fileserver database 54, etc.

The network server 50 may provide synchronization and backup services to the mobile terminal 100. The synchronization service is a service that periodically synchronizes the user profiles stored in the profile database 52 with the local user profile stored in the mobile terminal 100. The backup service is a service that periodically backs up specified files stored in the mobile terminal 100. File synchronization and backups may be initiated either by the mobile terminal 100 or by the network sever 50. For example, the user of the mobile terminal 100 may schedule the synchronization and backup at a specific time each day, e.g. 2:00 AM daily.

The file server database 54 may be used to implement a file-swapping service. Because memory 104 in a mobile terminal 100 is limited, a user may not be able to store all of their files in the mobile terminal memory 104. For example, the mobile terminal 100 may function as a media player that allows users to listen to their music. The user may have more music files that can be accommodated within the mobile terminal's memory 104. With only a limited amount of memory 104, the user must choose which song files to store in memory 104. Thus, the user's song choices are limited by what can be stored in memory 104. However, if the user stores music files in the file server database 54, the user can connect with the network server 50 to swap files stored in the mobile terminal memory 104 for files stored in the file server database 54 in the network 10. Thus, the user may have access to a vast library of songs that far exceeds the mobile terminal's memory capacity.

The network server 50 may be used to enable roaming profiles. On occasion, the user may need to borrow or rent a mobile terminal 100 owned by another. A user account may be set up containing an address to the user's roaming profile. Alternatively, the mobile terminal 100 may allow the user to log in as a guest user. In this case, the guest user may be prompted to enter the guest user's own phone number or other identifying information. Using information stored in the use account or entered by the user during login, the mobile terminal 100 may connect to the network server 50 to request download of the user's roaming profile. After downloading the user's roaming profile, the mobile terminal 100 can configure the mobile terminal 100 according to the user's roaming profile to the extent that the customized settings are compatible with the borrowed or leased mobile terminal 100. If no roaming profile exists for the user, a default profile may be used. When the user's roaming profile is downloaded from the network server 50, any needed files may be downloaded with the roaming profile. For example, if the roaming profile includes custom wallpapers or ring tones, the image file associated with the wallpaper and the sound file associated with the ring tone may be downloaded. Also, some of the user's data files, such as contact lists, email messages, or other such files, may be downloaded. The specific data files to be downloaded may be specified in the user's roaming profile. The roaming profile may also include account and billing information so that charges for the use of the borrowed or rented mobile terminal 100 can be charged to the roaming user, rather than the owner of the mobile terminal 100.

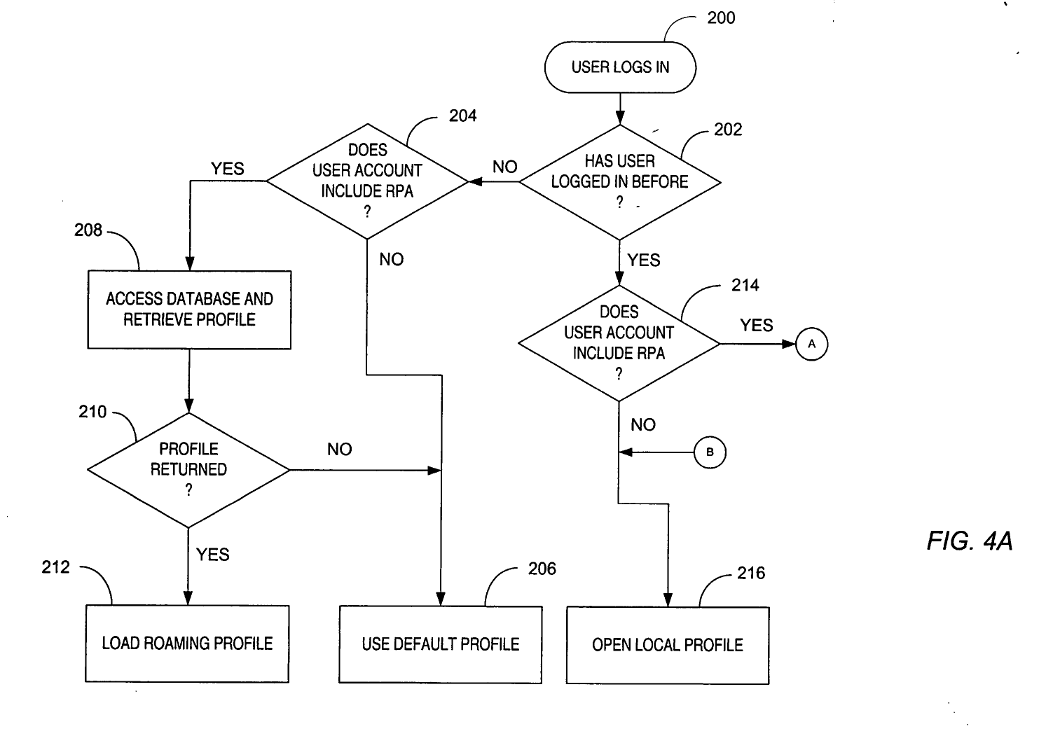

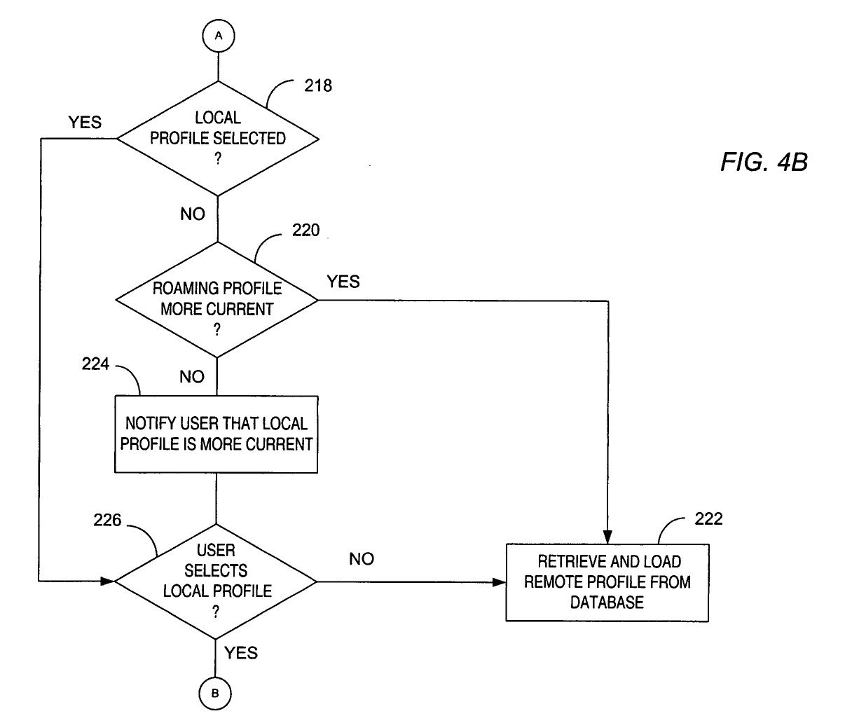

FIGS. 4A and 4B illustrate an exemplary log-in procedure for a mobile terminal 100. After the user logs in (block 200), the log-in procedure determines if the user has previously logged on (block 202). If not, the log-in procedure determines whether the user account contains a roaming profile address (block 204). If the user logs in as a guest user, the remote profile address may be determined based on information entered by the user during login. If no user profile path is specified, the log-in script creates a local user profile for the user based on a default user profile (block 206). If the user account indicates that the user has a roaming profile, the log-in procedure initiates communication with the network server 50 to retrieve the roaming profile from the network server 50 (block 208). If the network server 50 returns a user profile (block 210) the returned user profile is used to create a local user profile (block 212). If the network server 50 does not have a roaming profile for the user, the log-in script creates a user profile from the default user profile (block 206).

If the user has previously logged on, the log-in procedure determines whether the user account indicates that the user has a roaming profile (block 214). If not, the log-in script opens the local user profile for the user (block 216). If a roaming profile is indicated by the user account, the log-in script determines whether the user has selected the local profile (block 218). If so, the log-in script opens the local user profile (block 216). If the local user profile is not selected, the log-in script initiates communication with the network server 50 and determines whether the roaming profile is more current than the local user profile (block 220). If the roaming profile is more current, the roaming profile is downloaded from the database 52 (block 222). If the local profile is more current, the log-in script may notify the user that the local profile is more current (block 224) and prompt the user to use the local profile (block 226). Depending upon the user's response, the log-in script will either download the roaming profile (block 222) or open the local user profile (block 216). When the log-in script downloads the roaming profile from the database 52, the user may be prompted to create a local user profile or to replace or update the existing local user profile.

With the roaming user profile, the user may download their customized settings and preferences into any compatible mobile terminal 100. Thus, a user borrowing a mobile terminal 100 from a friend can have their own customized desktops and ring tones. Further, the downloaded user profile may indicate specific files to be downloaded along with the user profile. For customized desktop wallpaper, the corresponding image file may be downloaded. For a customized ring tone, the corresponding sound file may be downloaded. Additionally, the user's individual contact lists may be downloaded along with, or as part of, the profile. In one exemplary embodiment, an index of the user's contacts is downloaded along with the user's profile. When the user selects a contact, the contact information can be downloaded from the network and stored locally.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of configuring a mobile terminal for a user comprising:
determining whether the user has a roaming profile containing the user's configuration settings responsive to a login event;
if the user has a roaming profile, accessing the roaming profile in a remote profile database located in a remote network to determine the user's configuration settings; and
configuring the mobile terminal according to user configuration settings contained in the user's roaming profile.

2. The method of claim 1 wherein configuring the mobile terminal comprises configuring a user interface of the mobile terminal.

3. The method of claim 2 wherein configuring the user interface comprises configuring at least one of a desktop wallpaper, a screensaver, and a ringtone.

4. The method of claim 1 wherein configuring the mobile terminal comprises configuring a programmable function of the mobile terminal.

5. The method of claim 4 wherein configuring a programmable function of the mobile terminal comprises configuring a quick dial button.

6. The method of claim 1 wherein configuring the mobile terminal comprises configuring user preferences for one or more applications.

7. The method of claim 1 further comprising accessing the roaming profile located in the remote network to identify desired data files to be downloaded, and downloading the desired data files into local memory of the mobile terminal.

8. The method of claim 7 wherein the downloaded data files include at least one of a contact list, address book, and calendar.

9. The method of claim 1 further comprising creating and storing a local user profile in local memory based on said configuration settings in said roaming user profile.

10. The method of claim 9 further comprising periodically synchronizing the local user profile with the roaming profile.

11. A method of configuring a mobile terminal for a user comprising:
storing a local user profile in a local memory;
determining whether the user has a roaming profile responsive to a login event;
if the user has a roaming profile, selecting one of the roaming profile or the local profile as the active user profile; and
configuring the mobile terminal according to user configuration settings contained in the active user profile.

12. The method of claim 11 wherein selecting one of the roaming profile or the local profile as the active user profile comprises determining which of the roaming profile and local profile is most current.

13. The method of claim 12 wherein selecting one of the roaming profile or the local profile as the active user profile comprises notifying the user if the local profile is more current and prompting the user to select one of the local profile or roaming profile.

14. The method of claim 11 further comprising periodically synchronizing the local user profile with the roaming profile.

15. The method of claim 11 wherein configuring the mobile terminal comprises configuring a user interface of the mobile terminal.

16. The method of claim 15 wherein configuring the user interface comprises configuring at least one of a desktop wallpaper, a screensaver, and a ringtone.

17. The method of claim 11 wherein configuring the mobile terminal comprises configuring a programmable function of the mobile terminal.

18. The method of claim 17 wherein configuring a programmable function of the mobile terminal comprises configuring a quick dial button.

19. The method of claim 11 wherein configuring the mobile terminal comprises configuring user preferences for one or more applications.

20. A mobile terminal comprising:
a transceiver; and
a system processor operatively connected to said transceiver and responsive to a login event to:
determine configuration settings for a user by accessing the user's roaming profile stored in a remote network; and
configure the mobile terminal according configuration settings stored in the roaming profile.

21. The mobile terminal of claim 20 wherein the system processor configures a user interface of the mobile terminal.

22. The mobile terminal of claim 21 wherein the system processor configures one of a desktop wallpaper, a screensaver, and a ringtone.

23. The mobile terminal of claim 20 wherein the system processor configures a programmable function of the mobile terminal.

24. The mobile terminal of claim 20 wherein the system processor configures a quick dial button.

25. The mobile terminal of claim 20 wherein the system processor configures user preferences for one or more applications.

26. The mobile terminal of claim 20 wherein the system processor further accesses the roaming profile located in the network to identify desired data files to be downloaded, and downloads the desired data files into local memory of the mobile terminal.

27. The mobile terminal of claim 26 wherein the downloaded data files include one of a contact list, address book, or calendar.

28. The mobile terminal of claim 20 further comprising creating and storing a local user profile in local memory based on said configuration settings in said roaming user profile.

29. The mobile terminal of claim 28 further comprising periodically synchronizing the local user profile with the roaming profile.

30. An mobile terminal comprising:
a transceiver;
a local memory; and
a system processor operatively connected to said transceiver and to said local memory and responsive to a login event to:
determine whether the user has a roaming profile;
if the user has a roaming profile, select one of the roaming profile or the local profile as the active user profile; and
configure the mobile terminal according to user configuration settings contained in the active user profile.

31. The mobile terminal of claim 30 wherein the system processor configures a user interface of the mobile terminal.

32. The mobile terminal of claim 31 wherein the system processor configures one of a desktop wallpaper, a screensaver, and a ringtone.

33. The mobile terminal of claim 30 wherein the system processor configures a programmable function of the mobile terminal.

34. The mobile terminal of claim 30 wherein the system processor configures a quick dial button.

35. The mobile terminal of claim 30 wherein the system processor configures user preferences for one or more applications.

36. The mobile terminal of claim 30 wherein the system processor further accesses the roaming profile located in the network to identify desired data files to be downloaded, and downloads the desired data files into local memory of the mobile terminal.

37. The mobile terminal of claim 36 wherein the downloaded data files include one of a contact list, address book, or calendar.
